(19) United States
(12) Patent Application Publication
(10) Pub. No.: US 2008/0042322 A1
(43) Pub. Date: Feb. 21, 2008

(54) Platen-stroke actuator of molding system, amongst other things

(75) Inventors: Christopher Wai-Ming Choi, Richmond Hill (CA); Alex Teng, Richmond Hill (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, US

(73) Assignee: Husky Injection Molding Systems Ltd.

(21) Appl. No.: 11/505,057

(22) Filed: Aug. 15, 2006

(51) Int. Cl. B29C 45/00

(52) U.S. Cl. 264/328.1; 425/451.5; 425/451; 425/595

(57) ABSTRACT

Disclosed is: (i) a platen-stroke actuator of a molding system, (ii) a molding system having a platen-stroke actuator, (iii) a method of a platen-stroke actuator of a molding system, (iv) a molding-system controller of a molding system having a platen-stroke actuator, (v) an energization unit couplable to a molding-system controller of a molding system having a platen-stroke actuator, (vi) an article of manufacture of a molding system having a platen-stroke actuator and/or (vii) a network-transmittable signal of a molding system having a platen-stroke actuator, amongst other things.

### TECHNICAL FIELD

The present invention generally relates to molding systems, and more specifically the present invention relates to: (i) a platen-stroke actuator of a molding system, (ii) a molding system having a platen-stroke actuator, (iii) a method of a platen-stroke actuator of a molding system, (iv) a molding-system controller of a molding system having a platen-stroke actuator, (v) an energization unit couplable to a molding-system controller of a molding system having a platen-stroke actuator, (vi) an article of manufacture of a molding system having a platen-stroke actuator and/or (vii) a network-transmittable signal of a molding system having a platen-stroke actuator, amongst other things.

### BACKGROUND

Examples of the molding system 100 are: (i) the Hylectric™ System, (ii) the Quadloc™ System, (iii) the Hylectric™ System and (iv) the HyMet™ System, all manufactured by Husky Injection Molding Systems Limited (Location: Bolton, Ontario, Canada; www.husky.ca).

U.S. Pat. No. 4,385,877 (Inventor: Tanabe; Published: 1983-05-31) discloses an injection molding apparatus that includes a mold for an injection molding process, means to enable opening and closing of the mold, an annular magnetic coil for generating a magnetic field and disposed to enclose the outer periphery of the mold, and means to move the magnetic coil in directions related to the open and closed positions of the mold, characterized in that the mold has its outer periphery enclosed by the magnetic coil when the mold is closed and is clear of the magnetic coil when the mold is open.

U.S. Pat. No. 4,895,505 (Inventor: Inaba et al; Published 1990-01-23) discloses an injection molding machine having an injection mechanism, a mold clamping mechanism, an ejector, and a nozzle touch mechanism, each including a linear motion member which is linearly movable. The molding machine includes at least one linear motion electric motor having a stationary section and a movable section which is linearly movable relative to the stationary section, and means for operatively coupling each the movable section of the at least one linear motion electric motor to a corresponding one of the linear motion members of the injection mechanism, the mold clamping mechanism, the ejector, and the nozzle touch mechanism, so as to be movable in unison with the corresponding linear motion member.

U.S. Pat. No. 5,800,839 (Inventor: Kudo et al; Published: 1998-09-01) discloses a voice coil type linear motor including a cylindrical coil for magnetic field generation, a yoke extending along the coil, a magnet movable relatively to the coil in the axial direction thereof, and cooling means which cools the coil.

U.S. Pat. No. 6,124,648 (Inventor: Shibuya et al: Published: 2000-09-26) discloses a molding machine including a movable body and a drive unit for linearly moving the movable body, the drive unit including a linear motor including a linear movement body having a moving-side magnetic-pole portion and supported in an axially movable manner, the linear movement body being connected to the movable body, and a stationary body having a stationary-side magnetic-pole portion adapted to linearly move the linear movement body, wherein the linear movement body has a moving-side inclined surface on which part of the moving-side magnetic-pole portion is disposed, and the stationary body has a stationary-side inclined surface which faces the moving-side inclined surface and on which part of the stationary-side magnetic-pole portion is disposed.

U.S. Pat. No. 6,132,198 (Inventor: Tamaki et al; Published: 2000-10-17) discloses a tie-barless clamping apparatus for an injection molding machine. The apparatus includes a support frame having a base section, a first support section disposed on the base section and a second support section disposed on the base section opposite to the first support section, a stationary platen for holding a stationary mold, attached to the first support section of the support frame, an electromagnetic linear motor having a stator and a linear armature, the stator being fixed to the second support section of the support frame, and the linear armature being disposed so that a predetermined gap is formed between the stator and the linear armature, and a movable platen for holding a movable mold, disposed between the first and second support section of the support frame and capable of moving toward and away from the stationary platen according to a movement of the linear armature of the electromagnetic linear motor.

U.S. Pat. No. 6,247,913 (Inventor: Shibuya et al; Published: 2001-06-19) discloses a molding machine including a movable body and a drive unit having a rotary motor having a shaft that is rotatable and axially movable, a thrust generator for axially moving the shaft, the shaft being connected to the movable body in order to allow the movable body to be rotated by the rotary motor and be reciprocated by the thrust generator, a stator frame serving as a casing, an armature portion disposed along an inner circumferential surface of the stator frame, a field portion disposed on each of the inner surfaces of front and rear end walls of the stator frame, and a rotor portion provided on the shaft supported by the stator frame and including magnetic elements and non-magnetic elements arranged alternately in a circumferential direction.

U.S. Pat. No. 6,386,853 (Inventor: Mizuno et al; Published: 2002-05-14) discloses a motor-driven injection driving apparatus for an injection molding machine, which is configured so that the rotation of an electric motor is converted into linear motion, and an injection screw is moved forward and rearward by the linear motion. The motor-driven injection driving apparatus includes a fixed frame provided with an injection cylinder in which the injection screw is fitted so as to be moved forward and rearward, a movable frame which is provided so as to be moved forward and rearward in the axial direction of the injection cylinder and which is moved to the fixed frame side together with the screw upon the injection process, first and second injection drive motors installed on the fixed frame, first and second ball screw shafts pivotally supported on both sides of the fixed frame so as to be in parallel and symmetrical with respect to the axis of the injection cylinder and so as to be rotatable, the first and second ball screw shafts extending from the fixed frame to the movable frame, first and second power transmission mechanisms for transmitting the rotational forces of the first and second injection driving motors to the first and second ball screw shafts, respectively, while reducing the speed, first and second ball screw nuts, which are provided on both sides of the movable frame and threaded on ball threads of the first and second ball screw shafts, respectively, a screw drive motor, which is mounted on the movable frame, for rotatively driving the injection screw, and a controller for synchronously rotating the first and second injection drive motors, the movable frame being moved by rotation of the first and second ball screw.

United States Patent Application Number 2003/0185091 (Inventor: Koike et al; Published: 2003-10-02) discloses a voice coil type linear motor including a cylindrical coil for magnetic field generation, a yoke extending along the coil, a magnet movable relatively to the coil in the axial direction thereof, and cooling means which cools the coil.

United States Patent Application Number 2004/0018271 (Inventor: Yoshioka; Published: 2004-01-29) discloses a mold clamping mechanism for an injection molding machine including a stationary platen and a rear platen connected with each other by tie bars, a movable platen provided movable along the tie bars between the stationary platen and the rear platen, a link mechanism provided between the movable platen and the rear platen and including a first link member and a second link member, the first link member having one end pivotally connected to the movable platen and the other end pivotally connected to the second link member, and the second link member being connected to the rear platen to be linearly movable, and a liner motor for linearly moving the second link member.

U.S. Pat. No. 6,769,892 (Inventor: Hehl; Published: 2004-08-03) discloses an injection molding machine for processing plastics material and plasticisable materials. The machine includes an electric driving unit that is adapted to operate at least partially at least one of an injection molding unit and a mould closing unit, the electric driving unit including at least one linear motor, which has a rotor with magnets, disposed along it first cylindrical surface, and a stator with stator windings disposed along a second cylindrical surface, the first and second cylindrical surfaces being concentrically disposed, and the stator windings being substantially symmetrical relative to an axis of movement of the linear motor, wherein a plurality or identically acting first surfaces are stacked with a corresponding number of identically acting second surfaces, at least one of the first and second surfaces being operable jointly in operative connection, wherein the identically acting first or second surfaces are on an outside and inside of a first cylinder, and wherein the identically acting first and second surfaces are so disposed on concentric second and third cylinders that an internal surface of the second cylinder cooperates with the outside of the first cylinder, and an external surface of the third cylinder cooperates with the inside of the first cylinder.

United States Patent Application Number 2006/0082226 (Inventor: Protze; Published: 2006-04-20) discloses a magnetic linear drive including a base, and a first movable part, which can be moved along an axis, wherein a first magnetic force effect for movement of the first movable part is produced between the base and the first movable part, and a second magnetic force effect for movement of a second movable part is produced between the first movable part and the second movable part, which can be moved along the axis, wherein the second movable part is mounted such that it can move on the first movable part.

United States Patent Application Number 2006/0147578 (Inventor: Konno; Published: 2006-07-06) discloses a drive apparatus for an injection molding machine. The drive apparatus includes (i) a housing, (ii) a tubular linear motor comprising a movable element disposed within the housing in a manner capable of advancing and retreating, and a stationary element attached to the housing, the linear motor serving as a first drive section, (iii) a member-to-be-driven which is advanced and retreated together with the movable element through drive of the linear motor, and (iv) a second drive section attached to the housing and disposed such that at least a portion of the second drive section overlaps the linear motor along an axial direction.

### SUMMARY

According to a first aspect of the present invention, there is provided a platen-stroke actuator of a molding system, including a primary electro-magnetic element, and also including a secondary electro-magnetic element magnetically interactable with the primary electro-magnetic element, the primary electro-magnetic element extending away from a stationary frame of the molding system toward a secondary electro-magnetic element, the secondary electro-magnetic element extending away from a movable platen of the molding system toward the primary electro-magnetic element.

According to a second aspect of the present invention, there is provided a molding system, having an injection unit, a stationary platen cooperative with the injection unit, a movable platen movable relative to the stationary platen, a stationary frame stationed offset from the movable platen, and a platen-stroke actuator, including a primary electro-magnetic element and also including a secondary electro-magnetic element magnetically interactable with the primary electro-magnetic element, the primary electro-magnetic element extending away from the stationary frame toward a secondary electro-magnetic element, the secondary electro-magnetic element extending away from the movable platen toward the primary electro-magnetic element.

According to a third aspect of the present invention, there is provided a method of a platen-stroke actuator of a molding system, including extending a primary electro-magnetic element away from a stationary frame toward a secondary electro-magnetic element, extending the secondary electro-magnetic element away from a movable platen toward the primary electro-magnetic element, and interacting the secondary electro-magnetic element magnetically with the primary electro-magnetic element.

According to a fourth aspect of the present invention, there is provided a molding-system controller of a molding system, including a control unit, the control unit being operatively couplable to an energization unit, the energization unit being configured to energize any one combination of (i) a primary electro-magnetic element, (ii) a secondary electro-magnetic element and any combination and permutation thereof, the primary electro-magnetic element extending away from the stationary frame toward a secondary electro-magnetic element, the secondary electro-magnetic element extending away from the movable platen toward the primary electro-magnetic element, the control unit having a control-unit-usable medium embodying instructions, the control-unit-usable medium being couplable to the control unit, the instructions being executable by the control unit, the instructions including executable instructions for directing the control unit to actuate the energization unit so that upon magnetic interactivity between the secondary electro-magnetic element and the primary electro-magnetic element, the secondary electro-magnetic element and the movable platen are movable away from the stationary frame.

According to a fifth aspect of the present invention, there is provided for a molding system, a device, including an energization unit, the energization unit couplable to a molding-system controller having a control unit, the energization unit being configured to energize any one combination of (i) a primary electro-magnetic element, (ii) a secondary electro-magnetic element and any combination and permutation thereof, the primary electro-magnetic element extending away from the stationary frame toward a secondary electro-magnetic element, the secondary electro-magnetic element extending away from the movable platen toward the primary electro-magnetic element, the control unit having a control-unit-usable medium embodying instructions, the control-unit-usable medium being couplable to the control unit, the instructions being executable by the control unit, the instructions including executable instructions for directing the control unit to actuate the energization unit so that upon magnetic interactivity between the secondary electro-magnetic element and the primary electro-magnetic element, the secondary electro-magnetic element and the movable platen are movable away from the stationary frame.

According to a sixth aspect of the present invention, there is provided an article of manufacture of a molding system, including a control-unit-usable medium operatively couplable to a control unit of a molding-system controller, the control unit being operatively couplable to an energization unit, the energization unit being configured to energize any one combination of (i) a primary electro-magnetic element, (ii) a secondary electro-magnetic element and any combination and permutation thereof, the primary electro-magnetic element extending away from the stationary frame toward a secondary electro-magnetic element, the secondary electro-magnetic element extending away from the movable platen toward the primary electro-magnetic element, the control unit having a control-unit-usable medium embodying instructions, the control-unit-usable medium being couplable to the control unit, the instructions being executable by the control unit, the instructions including executable instructions for directing the control unit to actuate the energization unit so that upon magnetic interactivity between the secondary electromagnetic element and the primary electromagnetic element, the secondary electro-magnetic element and the movable platen are movable away from the stationary frame.

According to a seventh aspect of the present invention, there is provided an article of manufacture of a molding system, including a control-unit-usable medium operatively couplable to a control unit of a molding-system controller, the control unit being operatively couplable to an energization unit, the energization unit being configured to energize any one combination of (i) a primary electromagnetic element, (ii) a secondary electromagnetic element and any combination and permutation thereof, the primary electro-magnetic element extending away from the stationary frame toward a secondary electromagnetic element, the secondary electro-magnetic element extending away from the movable platen toward the primary electromagnetic element, the control unit having a control-unit-usable medium embodying instructions, the control-unit-usable medium being couplable to the control unit, the instructions being executable by the control unit, the instructions including executable instructions for directing the control unit to actuate the energization unit so that upon magnetic interactivity between the secondary electromagnetic element and the primary electromagnetic element, the secondary electro-magnetic element and the movable platen are movable away from the stationary frame.

According to an eighth aspect of the present invention, there is provided a network-transmittable signal of a molding system, including a carrier signal being modulatable to carry instructions over a network to a control-unit-usable medium, the control-unit-usable medium being operatively couplable to a molding-system controller having a control unit, the control unit being operatively couplable to an energization unit, the energization unit being configured to energize any one combination of (i) a primary electro-magnetic element, (ii) a secondary electro-magnetic element and any combination and permutation thereof, the primary electromagnetic element extending away from the stationary frame toward a secondary electromagnetic element, the secondary electromagnetic element extending away from the movable platen toward the primary electromagnetic element, the control unit having a control-unit-usable medium embodying instructions, the control-unit-usable medium being couplable to the control unit, the instructions being executable by the control unit, the instructions including executable instructions for directing the control unit to actuate the energization unit so that upon magnetic interactivity between the secondary electromagnetic element and the primary electromagnetic element, the secondary electro-magnetic element and the movable platen are movable away from the stationary frame.

A technical effect, amongst other technical effects, of the aspects of the present invention is improved ability to service the primary electromagnetic element and the secondary electro-magnetic element. Preferable embodiments of the present invention are subject of dependent claims.

### BRIEF DESCRIPTION OF THE DRAWINGS

A better understanding of the exemplary embodiments of the present invention (including alternatives and/or variations thereof) may be obtained with reference to the detailed description of the exemplary embodiments along with the following drawings, in which:

FIGS. 1 and 2 are schematic representations of a molding system according to a first embodiment (which is the preferred embodiment);

FIGS. 3 and 4 are schematic representations of a molding system according to a second exemplary embodiment.

FIG. 5 is a schematic representation of a molding system according to a third exemplary embodiment;

FIG. 6 is a schematic representation of a molding system according to a fourth exemplary embodiment;

FIG. 7 is a schematic representation of a variant of the molding system of FIG. 1;

FIG. 8 is a schematic representation of yet another variant of the molding system of FIG. 1;

FIG. 9 is a schematic representation of yet again another variant of the molding system of FIG. 1;

FIG. 10 is a schematic representation of yet again another variant of the molding system of FIG. 1; and

FIG. 11 is a schematic representation of system 100 of FIG. 7 according to a variant.

The drawings are not necessarily to scale and are sometimes illustrated by phantom lines, diagrammatic representations and fragmentary views. In certain instances, details that are not necessary for an understanding of the embodiments or that render other details difficult to perceive may have been omitted.

### DETAILED DESCRIPTION OF THE EXEMPLARY EMBODIMENTS

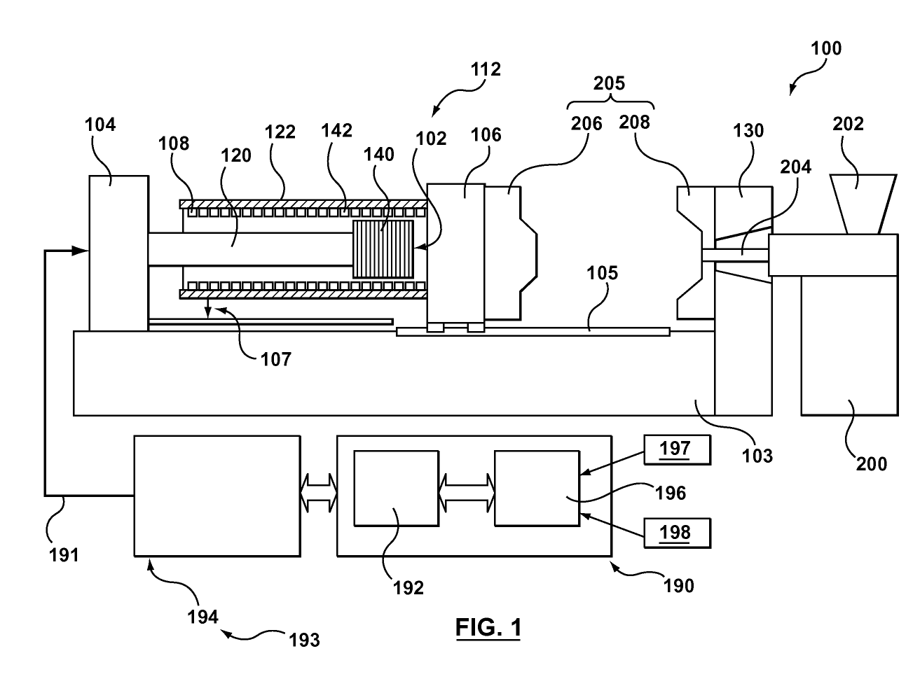

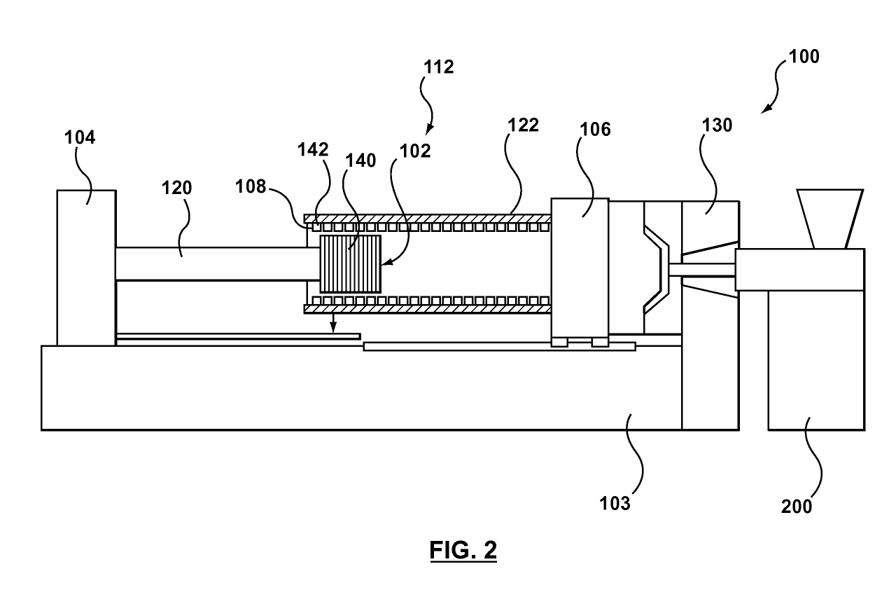

FIGS. 1 and 2 are schematic representations of a molding system 100 (hereafter referred to as “the system 100”) having a platen-stroke actuator 112 (hereafter referred to as the “actuator 112”) according to the first embodiment. The system 100 includes the platen-stroke actuator 112. The platen-stroke actuator 112 includes: (i) a primary electromagnetic element 102 (hereafter, from time to time, referred to as “the element 102”) and (ii) a secondary electromagnetic element 108 (hereafter, from time to time, referred to as “the element 108”). The element 102 extends away from a stationary frame 104 toward the element 108. The element 108 extends away from a movable platen 106 toward the element 102. The element 102 is magnetically interactable with the element 108 (when actuated to do so). The elements 102, 108 are used to move or stroke (linearly translate) the movable platen 106 so that a mold 205 may be opened or closed. The mold 205 includes a movable mold portion 206 and a stationary mold portion 208. FIG. 1 depicts the mold 205 in a mold-open condition, while FIG. 2 depicts the mold 205 in a mold-closed condition. It will be appreciated that the element 102 and the element 108 may form an induction motor that includes (i) a magnetizable material (steel, etc) or (ii) a permanent magnet or (iii) a coil, etc (in any combination or permutation as may be required). A technical effect, amongst other technical effects, is improved ability to service the primary electro-magnetic element 102 and the secondary electromagnetic element 108 (that is, ease of service).

Preferably, the element 102 is supportable by the stationary frame 104, while the element 108 is supportable by the movable platen 106. The stationary frame 104 is preferably attached to a stationary platen 130 of the system 100 (but this arrangement is not necessary). Upon actuation of magnetic interactivity between the element 102 and the element 108, the element 108 and the movable platen 106 are movable relative to (that is, away and toward) the stationary frame 104 while the element 102 and the stationary frame 104 do not move.

Preferably, the molding system 100 also includes (i) a clamping mechanism (not depicted) used to generate a clamping force, (ii) a mold-break force applicator (not depicted) used to generate a mold break force and (iii) tie bars (not depicted) that couple the clamping mechanism and the mold-break mechanism to the mold and the tie bars are used to transfer the clamping force and the mold-break force from the clamping mechanism and from the mold-break applicator, respectively, to the mold. Since the structure and operation of the clamping mechanism and the mold-break applicator are known to persons skilled in the art of molding systems, these mechanisms will not be described in detail and will not be illustrated. It will be appreciated that the FIGS. do not depict tie bars. The embodiments are applicable to a tiebarless-clamp orientation or a tiebar clamp orientation (that is, a conventional clamp that uses tiebars). It will be appreciated that the embodiments are equally applicable to both types of clamp arrangement (with or without tiebars). It will be appreciated that the stationary frame 104 is relatively stationary. According to a variant, the frame 104 is allowed to slide along the base to accommodate tiebar stretch.

Preferably, the stationary frame 104 is offset from the movable platen 106 and is also offset from the stationary platen 130. The movable platen 106 is movable between the stationary frame 104 and the stationary platen 130. The stationary frame 104 includes a base 103 that has guide rails 105; the movable platen 106 is movable along the guide rails 105 (or equivalent structure). The movable mold portion 206 (hereafter, from time to time, referred to as the “mold portion 206”) is attached to the movable platen 106; the stationary mold portion 208 (hereafter, from time to time, referred to as the “mold portion 208”) is attached to the stationary platen 130.

Preferably, the molding system 100 also includes (i) a clamping mechanism (not depicted) used to generate a clamping force, (ii) a mold-break force applicator (not depicted) used to generate a mold break force and (iii) tie bars (not depicted) that couple the clamping mechanism and the mold-break mechanism to the mold 205 and the tie bars are used to transfer the clamping force and the mold-break force from the clamping mechanism and from the mold-break applicator, respectively, to the mold 205. Since the structure and operation of the clamping mechanism and the mold-break applicator are known to persons skilled in the art of molding systems, these mechanisms will not be described in detail and will not be illustrated.

Preferably, the molding system 100 includes an injection unit 200 (also known as an extruder, either single screw or double screw, etc). Attached to the injection unit 200 is a hopper 202 for receiving a molding material. The injection unit 200 processes the molding material into a molten state and then injects the molten molding material into the mold 205 (that is, after the mold 205 has been closed and the clamping force has been applied to the mold 205). A machine nozzle 204 extends from the injection unit 200, through the stationary platen 130 and is coupled to the mold portion 208. The movable platen 106 is stroked (by the actuator 112) so as to close the mold portions 206, 208, the clamping force is applied to the mold 205, and the injection unit 200 injects the molten molding material, via the machine nozzle 204, into the mold 205. Once the mold 205 has molded an article, the mold-break force is applied to the mold 205 so as to separate the mold portions 206, 208 and then the article may be removed from the mold 205. According to an alternative, the molding system 100 accommodates an injection compression process, in which the molten molding material is injected into an open mold, and then the clamping force is applied to the mold. Preferably, a position sensor 107 is used to indicate a position of the movable platen 106 (if required).

Alternatively, the molding system 100 also includes a hot runner (not depicted) that is positioned between the mold portion 208 and the stationary platen 130, and the mold 205 defines multiple cavities, and the hot runner is used to fill the multiple cavities of the mold 205 with the molten molding material from the injection unit 200.

Preferably, the primary electromagnetic element 102 is receivable by the secondary electromagnetic element 108. The primary electromagnetic element 102 and the secondary electromagnetic element 108 overlap each other in part. A rod 120 (preferably, elongated) is connected to the stationary frame 104; the rod 120 extends from the stationary frame 104 toward the movable platen 106. The primary electromagnetic element 102 is attached to (or along) the rod 120. A cylinder 122 is connected to the movable platen 106; the cylinder 122 extends from the movable platen 106 toward the stationary frame 104. The secondary electro-magnetic element 108 is attached to (or along) the cylinder 122. The cylinder 122 is depicted in cross section as a matter of convenience to improve the view of the rod 120 and of the elements 102 and 108. The rod 120 and the cylinder 122 may have a cross-sectional shape that is circular-shaped or a square-shaped.

Preferably, the primary electromagnetic element 102 is lengthwise smaller than the secondary electro-magnetic element 108. The primary electromagnetic element 102 includes a primary coil 140 (that is, a coil of conducting wire of suitable gauge, etc). The secondary electro-magnetic element 108 includes a collection of secondary magnets 142. The magnets 142 are arranged in an alternating pattern of north-south polarity along a length, at least in part, of the cylinder 122. According to a variant (not depicted), the primary electromagnetic element 102 includes a primary coil 140, and the secondary electromagnetic element 108 includes a magnetic material, such as steel, etc.

Preferably, a molding-system controller 190 (hereafter referred to as “the controller 190”) is used to control the elements 102, 108. The controller 190 includes a control unit 192 (such as a microprocessor, a field-programmable gate array, digital signal processor, etc). The control unit 192 is operatively couplable to an energization unit 194. The energization unit 194 is configured to energize any one combination of (i) the primary electromagnetic element 102, (ii) a secondary electro-magnetic element 108 and (iii) the primary electromagnetic element 102 and the secondary electromagnetic element 108 in combination. According to the embodiment depicted in FIG. 1, the energization unit 194 is configured to energize the element 102 (since the element 102 includes a coil 140), and the energization unit 194 is not used to energize the element 108 (since the element 108 includes magnets or a magentizable material). The controller 190 also includes a control-unit-usable medium 196 (such as a hard drive or RAM memory, etc) embodying instructions that are executable by the control unit 192. The control-unit-usable medium 196 is couplable to the control unit 192. The instructions include executable instructions for directing the control unit 192 to actuate the energization unit 194 so that upon magnetic interactivity between the secondary electromagnetic element 108 and the primary electro-magnetic element 102, the secondary electromagnetic element 108 and the movable platen 106 are movable away from the stationary frame 104. The energization unit 194 may be sold separately as a separate item (that is, separate from the system 100), such as a device 193. By way of example, an example of a known energization unit is described in an article titled A New Method of partial Excitation for Dual Moving Magnet Linear Synchronous Motor, and the article may be found in a publication titled Transactions on Industry Applications published by the IEEE (Institute of Electrical and Electronics Engineers) Volume 40, Number 2 March/April 2004 starting from page 499. This known energization unit may be adapted to control the elements 102, 108.

An article of manufacture 198 may be used to deliver control instructions to the controller 190. The article of manufacture 198 includes the control-unit-usable medium 196, which in this case the medium 196 includes, for example, a floppy disk or an optical compact disk, or other type of easily-transported medium, etc. The medium 196 is operatively couplable to the controller 190 and also embodies instructions executable by the control unit 192.

As an alternative to the article of manufacture 198, a network-transmittable signal 197 is used to deliver control instructions to the controller 190. The signal 197 includes a carrier signal being modulatable to carry the instructions over a network (not depicted) to the control-unit-usable medium 196.

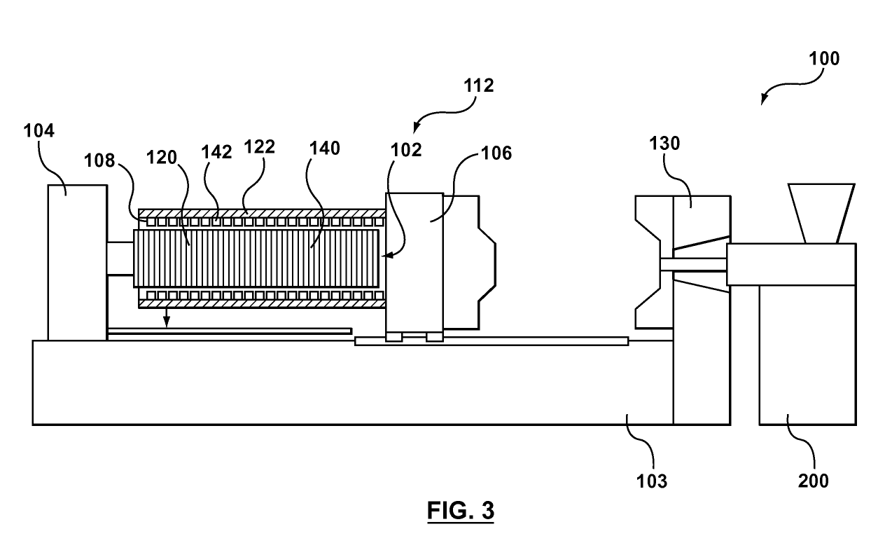

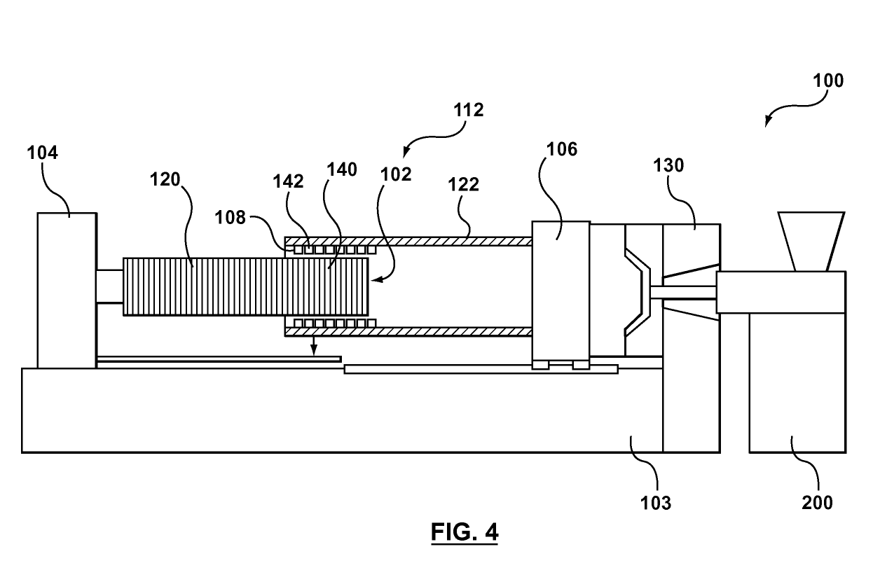

FIGS. 3 and 4 are schematic representations of the system 100 according to the second exemplary embodiment. FIG. 3 depicts the system 100 in the mold-opened condition while FIG. 4 depicts the molding system 100 in the mold-closed condition. According the second exemplary embodiment, the primary electromagnetic element 102 is lengthwise greater than the secondary electromagnetic element 108 (in sharp contrast to the first exemplary embodiment).

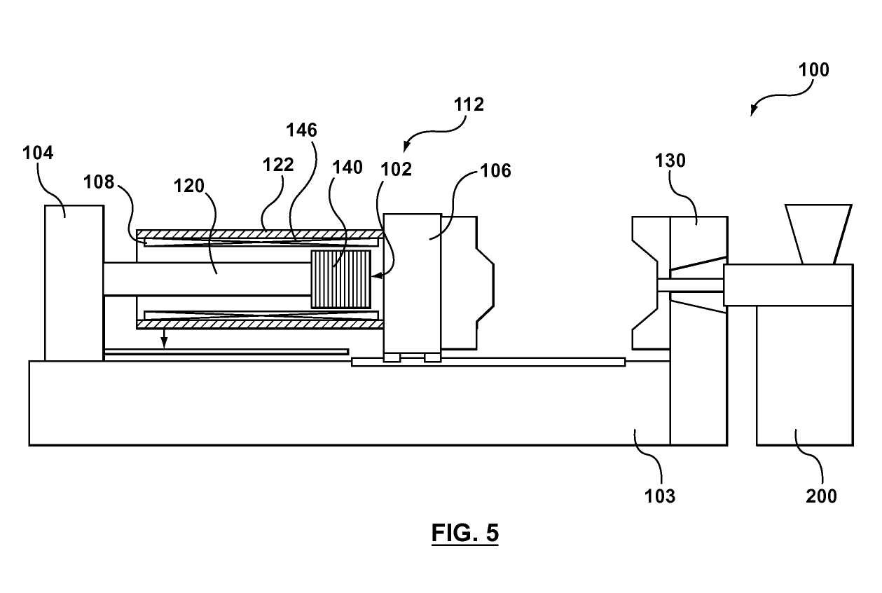

FIG. 5 is a schematic representation of the system 100 according to the third exemplary embodiment. The system 100 is depicted in the mold-opened condition. In sharp contrast to the first exemplary embodiment, the primary electromagnetic element 102 includes a primary coil 140; the secondary electromagnetic element 108 includes a secondary coil 146. According to the third exemplary embodiment, a cable track (not depicted) is used to house power lines to support the power lines and/or control cables that are connected to the coil 146.

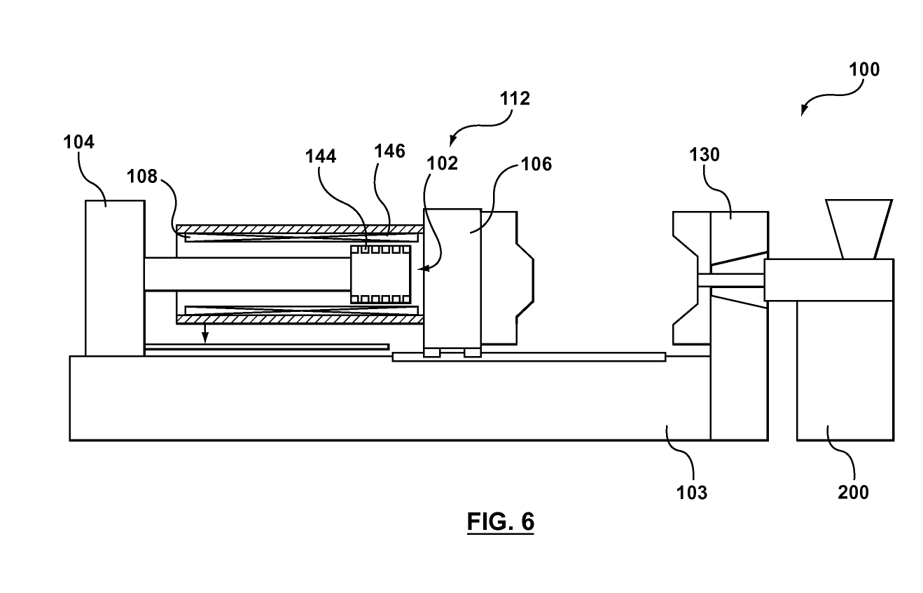

FIG. 6 is a schematic representation of the system 100 according to the fourth exemplary embodiment; the system 100 is depicted in the mold-opened condition. In sharp contrast to the first exemplary embodiment, the primary electromagnetic element 102 includes a collection of magnets or a magnetic material; the secondary electro-magnetic element 108 includes a secondary coil 146.

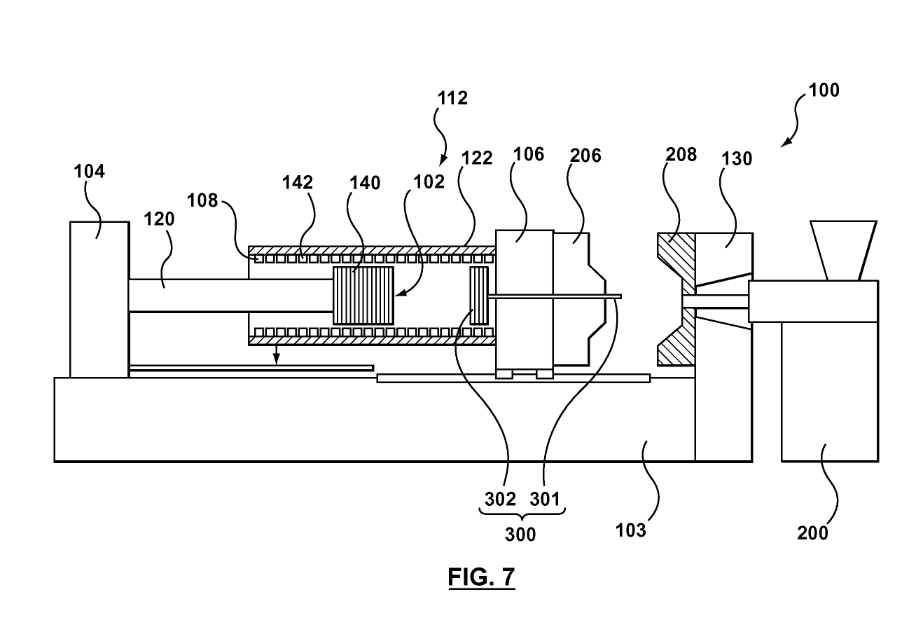

FIG. 7 is a schematic representation of a variant of the system 100 of FIG. 1. The movable platen 106 and the movable mold portion 206 both cooperate with an ejector mechanism 300. The ejector mechanism 300 has a slidable pin 301 (that is slidable through the movable platen 106 so as to eject parts from the mold 205). The ejector mechanism 300 also has an electromagnetic element 302 that is attached to a distal end of the pin 301. The electromagnetic element 302 is interactable with the secondary electromagnetic element 108 so as to slide the pin 301 back and forth as may be required.

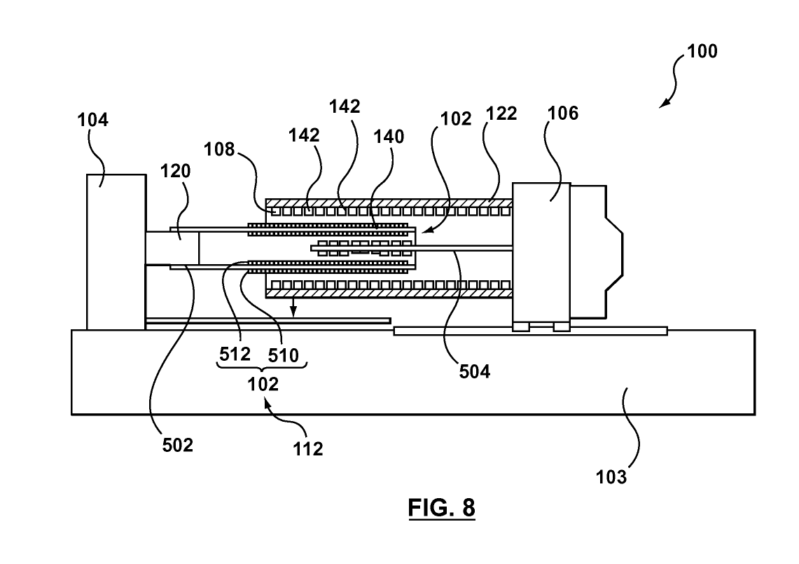

FIG. 8 is a schematic representation of yet another variant of the system 100 of FIG. 1. The rod 120 includes a primary cylinder 502 that extends from the rod 120; the rod 120 extends from the stationary frame 104 (the rod 120 may either be, preferably, solid or may be hollow). The primary electro-magnetic element 102 includes a first primary electromagnetic element 510 (either a coil or magnet) and also includes a second primary electromagnetic element 512 (either a magnet or a coil, respectively). The first primary electromagnetic element 510 is attached to an outer surface of the primary cylinder 502 so as to face the secondary electromagnetic element 108. The second primary electromagnetic element 512 is attached to an inner surface of the primary cylinder 502 and faces inwardly of the primary cylinder 502. The primary cylinder 502 is nestable (receivable) in the cylinder 122 (the cylinder 122 includes the secondary electro-magnetic element 108). A secondary rod 504 extends from a central area of the movable platen 106. The secondary rod 504 is nestable (receivable) in the primary cylinder 502. A technical effect of this arrangement is generation of stronger (magnetic) forces that may be used to stroke the movable platen 106.

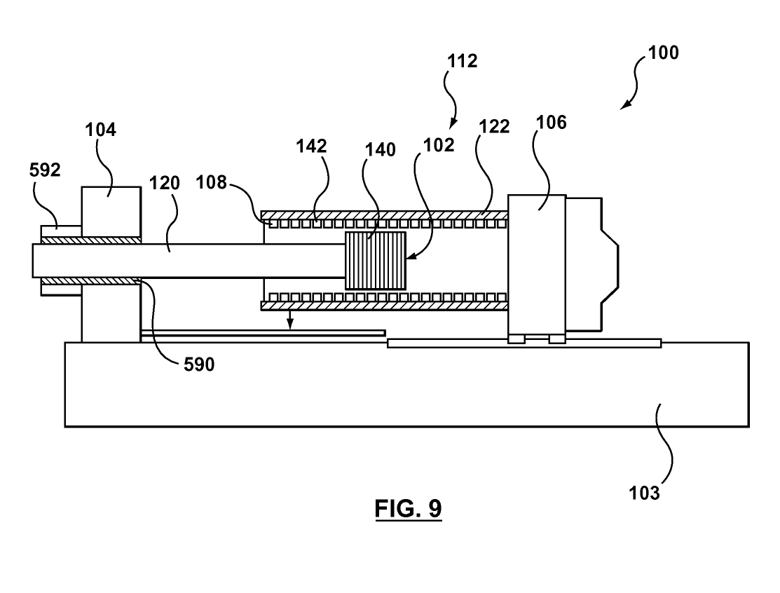

FIG. 9 is a schematic representation of yet again another variant of the system 100 of FIG. 1. The rod 120 is positionably translatable (adjustable) relative to the stationary frame 104 so as to, preferably, accommodate for mold shut-height adjustment. Preferably, the rod 120 is threadably engageable, by way of threads 590, with the stationary frame 104; a lock nut 592 is used to maintain engagement of the rod 120 relative to the stationary frame 104.

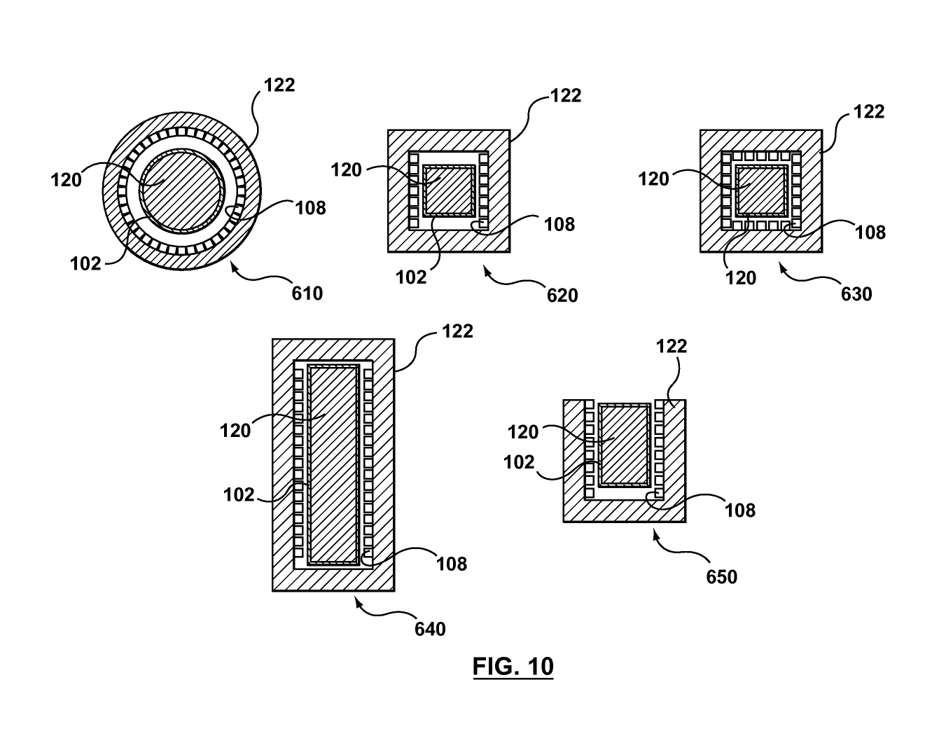

FIG. 10 is a schematic representation of yet again another variant of the system 100 of FIG. 1. The primary electromagnetic element 102 and the secondary electromagnetic element 108 and the rod 120 and the cylinder 122 are depicted in cross sections. The primary electro-magnetic element 102 and the secondary electromagnetic element 108 are attached to the rod 120 and the cylinder 122 respectively; the rod 120 is nestable in the cylinder 122. The cylinder 122 and the rod 120 each have any one of (i) a circular-shaped cross section 610, (ii) a square-shaped cross section 620, 630, (iii) a rectangular-shaped cross section 640, and (iv) a U-shaped cross section 650. The U-shaped cross section 650 is preferred because the electromagnetic forces acting on the cylinder 122 and the rod 120. It will be appreciated that the primary 102 and the secondary 108 may be placed on the rod 120 and the cylinder 122 respectively, or the primary 102 and the secondary 108 may be placed on the cylinder 122 and rod 120 respectively.

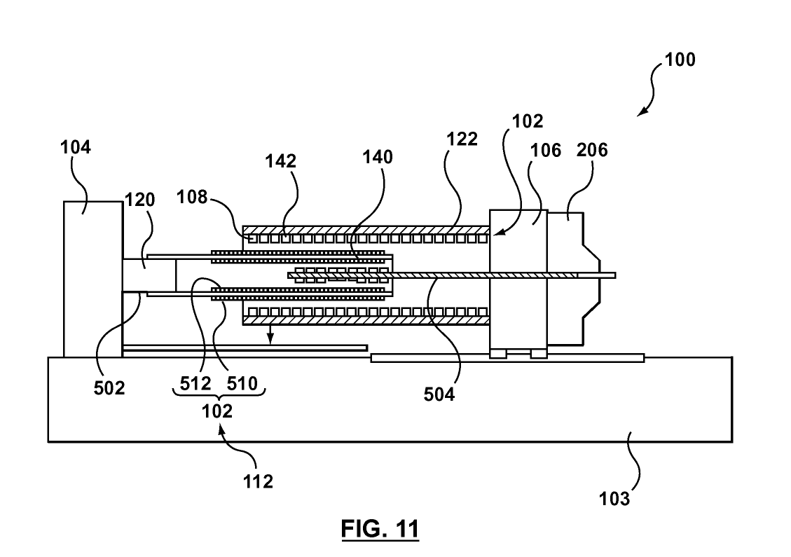

FIG. 11 is a schematic representation of system 100 of FIG. 7 according to a variant. The rod 120 includes a primary cylinder 502 that extends from the rod 120; the rod 120 extends from the stationary frame 104 (the rod 120 may either be, preferably, solid or may be hollow). The primary electromagnetic element 102 includes a first primary electromagnetic element 510 (either a coil or magnet) and also includes a second primary electromagnetic element 512 (either a magnet or a coil, respectively). The first primary electromagnetic element 510 is attached to an outer surface of the primary cylinder 502 so as to face the secondary electromagnetic element 108. The second primary electromagnetic element 512 is attached to an inner surface of the primary cylinder 502 and faces inwardly of the primary cylinder 502. The primary cylinder 502 is nestable (receivable) in the cylinder 122 (the cylinder 122 includes the secondary electro-magnetic element 108). A secondary rod 504 is used as an ejector mechanism. The secondary rod is slidably mounted to the movable platen 106 so as to slide through the mold movable portion 206 and thereby eject a part from the mold 205. The secondary rod 504 is nestable (receivable) in the primary cylinder 502.

The description of the exemplary embodiments provides examples of the present invention, and these examples do not limit the scope of the present invention. It is understood that the scope of the present invention is limited by the claims. The concepts described above may be adapted for specific conditions and/or functions, and may be further extended to a variety of other applications that are within the scope of the present invention. Having thus described the exemplary embodiments, it will be apparent that modifications and enhancements are possible without departing from the concepts as described. Therefore, what is to be protected by way of letters patent are limited only by the scope of the following:

What is claimed is:

1. A platen-stroke actuator of a molding system, comprising:
a primary electromagnetic element; and
a secondary electromagnetic element magnetically interactable with the primary electro-magnetic element, the primary electromagnetic element extending away from a stationary frame of the molding system toward a secondary electromagnetic element, the secondary electro-magnetic element extending away from a movable platen of the molding system toward the primary electromagnetic element.

2. The platen-stroke actuator of claim 1, wherein:
the stationary frame includes a rod, the rod connectable to and extending from the stationary frame toward the movable platen, the primary electro-magnetic element attachable to the rod, and
the movable platen includes a cylinder, the cylinder attachable to and extending from the movable platen toward the stationary frame, the secondary electromagnetic element attachable to the cylinder.

3. The platen-stroke actuator of claim 1, wherein upon actuation of magnetic interactivity between the secondary electromagnetic element and the primary electromagnetic element, the secondary electromagnetic element and the movable platen are movable away from the stationary frame.

4. The platen-stroke actuator of claim 1, wherein the primary electromagnetic element is supportable by the stationary frame, the secondary electromagnetic element is supportable by the movable platen.

5. The platen-stroke actuator of claim 1, wherein the primary electromagnetic element is receivable by the secondary electromagnetic element.

6. The platen-stroke actuator of claim 1, wherein the primary electromagnetic element includes any one of a primary coil, a collection of primary magnets, a magnetic material and any combination and permutation thereof.

7. The platen-stroke actuator of claim 1, wherein the secondary electromagnetic element includes a collection of secondary magnets, a secondary coil, a magnetic material and any combination and permutation thereof.

8. The platen-stroke actuator of claim 1, wherein the movable platen is configured to cooperate with an ejector mechanism, the ejector mechanism having a slidable pin and also having an electromagnetic element attached to the pin, the electromagnetic element interactable with the secondary electromagnetic element.

9. The platen-stroke actuator of claim 1, wherein:
the stationary frame includes a rod, the rod connectable to and extending from the stationary frame toward the movable platen, the primary electromagnetic element attachable to the rod,
the movable platen includes a cylinder, the cylinder attachable to and extending from the movable platen toward the stationary frame, the secondary electromagnetic element attachable to the cylinder,
the rod includes a primary cylinder nestable in the rod, and
the movable platen includes a secondary rod nestable in the primary cylinder.

10. The platen-stroke actuator of claim 1, wherein:
the stationary frame includes a rod, the rod connectable to and extending from the stationary frame toward the movable platen, the primary electromagnetic element attachable to the rod, and
the movable platen includes a cylinder, the cylinder attachable to and extending from the movable platen toward the stationary frame, the secondary electromagnetic element attachable to the cylinder,
the rod includes a primary cylinder nestable in the rod, the primary cylinder extending from the stationary frame, and
the movable platen includes a secondary rod nestable in the primary cylinder, the secondary rod extending from the movable platen.

11. The platen-stroke actuator of claim 1, wherein:
the stationary frame includes a rod, the rod connectable to and extending from the stationary frame toward the movable platen, the primary electromagnetic element attachable to the rod, and
the movable platen includes a cylinder, the cylinder attachable to and extending from the movable platen toward the stationary frame, the secondary electromagnetic element attachable to the cylinder,
the cylinder having any one of a circular-shaped cross section, a square-shaped cross section, a rectangular-shaped cross section, a U-shaped cross section and in any combination any permutation thereof, and
the rod having any one of a circular-shaped cross section, a square-shaped cross section, a rectangular-shaped cross section, a U-shaped cross section and in any combination any permutation thereof.

12. A molding system, comprising:
an injection unit;
a stationary platen cooperative with the injection unit;
a movable platen movable relative to the stationary platen;
a stationary frame stationed offset from the movable platen; and
a platen-stroke actuator, including:
a primary electromagnetic element; and
a secondary electromagnetic element magnetically interactable with the primary electromagnetic element, the primary electromagnetic element extending away from the stationary frame toward a secondary electromagnetic element, the secondary electro-magnetic element extending away from the movable platen toward the primary electro-magnetic element.

13. The molding system of claim 12 wherein:
the stationary frame includes a rod, the rod connectable to and extending from the stationary frame toward the movable platen, the primary electromagnetic element attachable to the rod, and
the movable platen includes a cylinder, the cylinder attachable to and extending from the movable platen toward the stationary frame, the secondary electromagnetic element attachable to the cylinder.

14. The molding system of claim 12, wherein upon actuation of magnetic interactivity between the secondary electromagnetic element and the primary electromagnetic element, the secondary electromagnetic element and the movable platen are movable away from the stationary frame.

15. The molding system of claim 12, wherein the primary electromagnetic element is supportable by the stationary frame, the secondary electromagnetic element is supportable by the movable platen.

16. The molding system of claim 12, wherein the primary electromagnetic element is receivable by the secondary electromagnetic element.

17. The molding system of claim 12, wherein the primary electromagnetic element includes any one of a primary coil, a collection of primary magnets, a magnetic material and any combination and permutation thereof.

18. The molding system of claim 12, wherein the secondary electromagnetic element includes a collection of secondary magnets, a secondary coil, a magnetic material and any combination and permutation thereof.

19. The molding system of claim 12, wherein the movable platen is configured to cooperate with an ejector mechanism, the ejector mechanism having a slidable pin and also having an electromagnetic element attached to the pin, the electromagnetic element interactable with the secondary electro-magnetic element.

20. The molding system of claim 12, wherein:
the stationary frame includes a rod, the rod connectable to and extending from the stationary frame toward the movable platen, the primary electromagnetic element attachable to the rod,
the movable platen includes a cylinder, the cylinder attachable to and extending from the movable platen toward the stationary frame, the secondary electromagnetic element attachable to the cylinder,
the rod includes a primary cylinder nestable in the rod, and
the movable platen includes a secondary rod nestable in the primary cylinder.

21. The molding system of claim 1, wherein:
the stationary frame includes a rod, the rod connectable to and extending from the stationary frame toward the movable platen, the primary electromagnetic element attachable to the rod, and
the movable platen includes a cylinder, the cylinder attachable to and extending from the movable platen toward the stationary frame, the secondary electromagnetic element attachable to the cylinder,
the rod includes a primary cylinder nestable in the rod, the primary cylinder extending from the stationary frame, and
the movable platen includes a secondary rod nestable in the primary cylinder, the secondary rod extending from the movable platen.

22. The molding system of claim 1,
the stationary frame includes a rod, the rod connectable to and extending from the stationary frame toward the movable platen, the primary electromagnetic element attachable to the rod,
the movable platen includes a cylinder, the cylinder attachable to and extending from the movable platen toward the stationary frame, the secondary electromagnetic element attachable to the cylinder,
the cylinder having any one of a circular-shaped cross section, a square-shaped cross section, a rectangular-shaped cross section, a U-shaped cross section and in any combination any permutation thereof, and
the rod having any one of a circular-shaped cross section, a square-shaped cross section, a rectangular-shaped cross section, a U-shaped cross section and in any combination any permutation thereof.

23. A method of a platen-stroke actuator of a molding system, comprising:
magnetically interacting a primary electromagnetic element with a secondary electro-magnetic element, the primary electromagnetic element extending a away from a stationary frame toward the secondary electro-magnetic element, the secondary electromagnetic element extending away from a movable platen toward the primary electromagnetic element.

24. The method of claim 23, further comprising:
having the stationary frame include a rod connectable to and extending from the stationary frame toward the movable platen;
attaching the primary electromagnetic element to the rod;
having the movable platen include a cylinder attachable to and extending from the movable platen toward the stationary frame; and
attaching the secondary electromagnetic element to the cylinder.

25. The method of claim 23, further comprising:
actuating magnetic interactivity between the secondary electromagnetic element and the primary electromagnetic element so that the secondary electromagnetic element and the movable platen are movable away from the stationary frame.

26. The method of claim 23,
supporting the primary electromagnetic element by the stationary frame; and
supporting the secondary electromagnetic element by the movable platen.

27. The method of claim 23, further comprising:
receiving the primary electro-magnetic element in the secondary electro-magnetic element.

28. The method of claim 23, wherein the primary electromagnetic element includes any one of a primary coil, a collection of primary magnets, a magnetic material and any combination and permutation thereof.

29. The method of claim 23, wherein the secondary electromagnetic element includes a collection of secondary magnets, a secondary coil, a magnetic material and any combination and permutation thereof.

30. The method of claim 23, wherein the movable platen is configured to cooperate with an ejector mechanism, the ejector mechanism having a slidable pin and also having an electromagnetic element attached to the pin, the electromagnetic element interactable with the secondary electromagnetic element.

31. The method of claim 23, wherein:
the stationary frame includes a rod, the rod connectable to and extending from the stationary frame toward the movable platen, the primary electromagnetic element attachable to the rod,
the movable platen includes a cylinder, the cylinder attachable to and extending from the movable platen toward the stationary frame, the secondary electromagnetic element attachable to the cylinder,
the rod includes a primary cylinder nestable in the rod, and
the movable platen includes a secondary rod nestable in the primary cylinder.

32. The method of claim 23, wherein:
the stationary frame includes a rod, the rod connectable to and extending from the stationary frame toward the movable platen, the primary electromagnetic element attachable to the rod,
the movable platen includes a cylinder, the cylinder attachable to and extending from the movable platen toward the stationary frame, the secondary electromagnetic element attachable to the cylinder,
the rod includes a primary cylinder nestable in the rod, the primary cylinder extending from the stationary frame, and
the movable platen includes a secondary rod nestable in the primary cylinder, the secondary rod extending from the movable platen.

33. The method of claim 23, wherein:
the stationary frame includes a rod, the rod connectable to and extending from the stationary frame toward the movable platen, the primary electromagnetic element attachable to the rod,
the movable platen includes a cylinder, the cylinder attachable to and extending from the movable platen toward the stationary frame, the secondary electromagnetic element attachable to the cylinder,
the cylinder having any one of a circular-shaped cross section, a square-shaped cross section, a rectangular-shaped cross section, a U-shaped cross section and in any combination any permutation thereof, and
the rod having any one of a circular-shaped cross section, a square-shaped cross section, a rectangular-shaped cross section, a U-shaped cross section and in any combination any permutation thereof.

34. A molding-system controller of a molding system, comprising:
a control unit, the control unit being operatively couplable to an energization unit, the energization unit being configured to energize any one combination of (i) a primary electro-magnetic element, (ii) a secondary electromagnetic element and any combination and permutation thereof, the primary electromagnetic element extending away from the stationary frame toward a secondary electromagnetic element, the secondary electromagnetic element extending away from the movable platen toward the primary electromagnetic element, the control unit having a control-unit-usable medium embodying instructions, the control-unit-usable medium being couplable to the control unit, the instructions being executable by the control unit, the instructions including executable instructions for directing the control unit to actuate the energization unit so that upon magnetic interactivity between the secondary electromagnetic element and the primary electromagnetic element, the secondary electromagnetic element and the movable platen are movable away from the stationary frame.

35. The molding-system controller of claim 34, wherein:
the stationary frame includes a rod, the rod connectable to and extending from the stationary frame toward the movable platen, the primary electromagnetic element attachable to the rod, and
the movable platen includes a cylinder, the cylinder attachable to and extending from the movable platen toward the stationary frame, the secondary electromagnetic element attachable to the cylinder.

36. For a molding system, a device, comprising:
an energization unit, the energization unit couplable to a molding-system controller having a control unit, the energization unit being configured to energize any one combination of (i) a primary electromagnetic element, (ii) a secondary electromagnetic element and any combination and permutation thereof, the primary electromagnetic element extending away from the stationary frame toward a secondary electromagnetic element, the secondary electro-magnetic element extending away from the movable platen toward the primary electromagnetic element, the control unit having a control-unit-usable medium embodying instructions, the control-unit-usable medium being couplable to the control unit, the instructions being executable by the control unit, the instructions including executable instructions for directing the control unit to actuate the energization unit so that upon magnetic interactivity between the secondary electromagnetic element and the primary electromagnetic element, the secondary electro-magnetic element and the movable platen are movable away from the stationary frame.

37. The a device of claim 36, wherein:
the stationary frame includes a rod, the rod connectable to and extending from the stationary frame toward the movable platen, the primary electromagnetic element attachable to the rod, and
the movable platen includes a cylinder, the cylinder attachable to and extending from the movable platen toward the stationary frame, the secondary electromagnetic element attachable to the cylinder.

38. An article of manufacture of a molding system, comprising:
a control-unit-usable medium operatively couplable to a control unit of a molding-system controller, the control unit being operatively couplable to an energization unit, the energization unit being configured to energize any one combination of (i) a primary electromagnetic element, (ii) a secondary electromagnetic element and any combination and permutation thereof, the primary electromagnetic element extending away from the stationary frame toward a secondary electromagnetic element, the secondary electromagnetic element extending away from the movable platen toward the primary electromagnetic element,
the control unit having a control-unit-usable medium embodying instructions, the control-unit-usable medium being couplable to the control unit, the instructions being executable by the control unit, the instructions including executable instructions for directing the control unit to actuate the energization unit so that upon magnetic interactivity between the secondary electro-magnetic element and the primary electromagnetic element, the secondary electro-magnetic element and the movable platen are movable away from the stationary frame.

39. The article of manufacture of claim 38, wherein:
the stationary frame includes a rod, the rod connectable to and extending from the stationary frame toward the movable platen, the primary electromagnetic element attachable to the rod, and
the movable platen includes a cylinder, the cylinder attachable to and extending from the movable platen toward the stationary frame, the secondary electromagnetic element attachable to the cylinder.

40. A network-transmittable signal of a molding system, comprising:
a carrier signal being modulatable to carry instructions over a network to a control-unit-usable medium, the control-unit-usable medium being operatively couplable to a molding-system controller having a control unit, the control unit being operatively couplable to an energization unit, the energization unit being configured to energize any one combination of (i) a primary electromagnetic element, (ii) a secondary electromagnetic element and any combination and permutation thereof, the primary electromagnetic element extending away from the stationary frame toward a secondary electromagnetic element, the secondary electro-magnetic element extending away from the movable platen toward the primary electromagnetic element, the control unit having a control-unit-usable medium embodying instructions, the control-unit-usable medium being couplable to the control unit, the instructions being executable by the control unit, the instructions including executable instructions for directing the control unit to actuate the energization unit so that upon magnetic interactivity between the secondary electromagnetic element and the primary electro-magnetic element, the secondary electromagnetic element and the movable platen are movable away from the stationary frame.

41. The network-transmittable signal of claim 40, wherein:
the stationary frame includes a rod, the rod connectable to and extending from the stationary frame toward the movable platen, the primary electromagnetic element attachable to the rod, and
the movable platen includes a cylinder, the cylinder attachable to and extending from the movable platen toward the stationary frame, the secondary electromagnetic element attachable to the cylinder.
